(19) United States
(12) Patent Application Publication
(10) Pub. No.: US 2026/0147853 A1
(43) Pub. Date: May 28, 2026

(54) VERTICAL MATRIX MULTIPLICATION OPERATION DEVICE AND METHOD OF MANUFACTURING THE SAME

(71) Applicant: Kwangwoon University Industry-Academic Collaboration Foundation, Seoul (KR)

(72) Inventor: Daeseok Lee, Seoul (KR)

(21) Appl. No.: 19/315,535

(22) Filed: Aug. 30, 2025

(30) Foreign Application Priority Data
Nov. 22, 2024 (KR) 10-2024-0168352

(51) Int. Cl. G06F 17/16; G06N 3/06

(52) U.S. Cl. CPC G06F 17/16; G06N 3/06

(57) ABSTRACT

The present disclosure may provide a vertical matrix multiplication operation device according to an embodiment and a method of manufacturing the same. The matrix multiplication operation device may be highly integrated by a structure according to an embodiment, thereby dramatically improving a performance of an operation system for unstructured data.

### CROSS-REFERENCE TO RELATED PATENT APPLICATION

This application claims the benefit of Korean Patent Application No. 10-2024-0168352, filed on Nov. 22, 2024, in the Korean Intellectual Property Office, the disclosure of which is incorporated herein in its entirety by reference.

### TECHNICAL FIELD

The present disclosure relates to an artificial intelligence operation acceleration device, and more specifically to a method of manufacturing a matrix multiplication operation device by forming a network using a synapse element and a neuron element.

### BACKGROUND

According to a rapid increase in use of unstructured data and utilization of an artificial intelligence algorithm, a new energy-efficient operation system that is different from a conventional von Neumann system is required. It is necessary to efficiently implement a matrix multiplication operation for the operation system. The matrix multiplication operation goes through a multiplication-accumulation (MAC) operation, and a neural network structure consisting of a weight element and an activation function element has been proposed as one of research on the MAC operation device.

The neural network is an artificial intelligence (AI) system that mimics a neural network of a human brain. The neural network is mainly used to process an input signal to learn or predict a specific task. The neural network consists of a plurality of layers, and the weight element and the activation function element play important roles in each layer.

The weight element is a parameter that plays an important role in each connection of the neural network. A weight value assigned to each connection of the neural network determines importance of the input signal. The larger the weight value, the greater the influence of the signal in the connection on the output, while a small weight reduces the influence of the signal.

The activation function element serves to nonlinearly convert an output value of a neuron. Through this, the network may also learn complex problems that cannot be solved by a linear combination. An activation function may be in various forms. For example, a rectified linear unit (ReLU) function outputs 0 when an input is less than 0, and outputs the value as it is when the input is greater than 0. The ReLU function is an activation function that speeds up learning and is widely used in deep learning. A sigmoid function is often used in a binary classification problem by converting the output value to a real number between 0 and 1. A tan h function converts the output value to between −1 and 1, and has a characteristic that the output is further distributed at a value close to the center compared to the sigmoid function.

### SUMMARY

### Technical Problem

The present disclosure is directed to providing a matrix multiplication operation device with a vertical structure.

The problems to be solved by the present disclosure are not limited to the problems described above, and other problems not mentioned will be clearly understood by those having ordinary skill in the art from the description below.

### Technical Solution

A matrix multiplication operation device according to an embodiment of the present disclosure may include: a plurality of input metal layers disposed in a direction perpendicular to a substrate; a plurality of insulating layers that electrically separate the plurality of input metal layers; and a plurality of hole structures extending in the direction perpendicular to the substrate and penetrating the plurality of input metal layers and the plurality of insulating layers, respectively, wherein inside of each of the plurality of hole structures may include an output metal pole extending in the direction perpendicular to the substrate, an activation function layer surrounding the output metal pole and extending in the direction perpendicular to the substrate, an intermediate metal layer surrounding the activation function layer and extending in the direction perpendicular to the substrate, and a weight layer surrounding the intermediate metal layer and extending in the direction perpendicular to the substrate. The weight layer may constitute a center portion of each of a plurality of weight elements disposed in the direction perpendicular to the substrate. Each of the plurality of weight elements may receive an input signal in a direction parallel to the substrate through the plurality of input metal layers. The output metal pole of the inside of each of the plurality of hole structures may output an output signal in the direction perpendicular to the substrate. The input signal may be in a current form.

A matrix multiplication operation element according to another embodiment of the present disclosure may include: an output metal pole extending in a direction perpendicular to a substrate; an activation function layer surrounding the output metal pole and extending in the direction perpendicular to the substrate; an intermediate metal layer surrounding the activation function layer and extending in the direction perpendicular to the substrate; a weight layer surrounding the intermediate metal layer and extending in the direction perpendicular to the substrate; a plurality of input metal layers that are in contact with the weight layer in a direction parallel to the substrate and disposed in the direction perpendicular to the substrate; and a plurality of insulating layers that electrically separate the plurality of input metal layers. The intermediate metal layer, the weight layer, and the plurality of input metal layers may constitute a plurality of weight elements. The plurality of weight elements may receive an input signal in the direction parallel to the substrate through the plurality of input metal layers. The output metal pole may output an output signal in the direction perpendicular to the substrate. The input signal may be in a current form.

### Advantageous Effects

A matrix multiplication operation device can be highly integrated by a structure provided in the present disclosure, thereby dramatically improving a performance of an operation system for unstructured data.

The effects according to the present disclosure are not limited to the effects described above, and other effects not mentioned will be clearly understood by those having ordinary skill in the art from the description below.

### BRIEF DESCRIPTION OF THE DRAWINGS

FIG. 1 is a view for describing a basic structure of a neural network according to an embodiment of the present disclosure.

FIG. 2 is a circuit diagram for implementing a neural network structure as hardware according to an embodiment of the present disclosure.

FIG. 3 is a view for describing a structure of a matrix multiplication operation device and element according to an embodiment of the present disclosure.

FIG. 4 is a flowchart describing a method of manufacturing a matrix multiplication operation element according to an embodiment of the present disclosure.

FIG. 5 is a graph for describing transfer characteristics (step function) of a metal-insulator transition (MIT) element, which is an exemplary activation function element of the matrix multiplication operation device according to an embodiment of the present disclosure.

FIG. 6 is a graph for describing another transfer characteristics (rectified linear unit (ReLU) function) of the MIT element, which is the exemplary activation function element of the matrix multiplication operation device according to an embodiment of the present disclosure.

FIG. 7 is a view for describing an operation of the matrix multiplication operation device according to an embodiment of the present disclosure in association with a matrix multiplication operation concept diagram 700 and a single-layer neural network model 704.

FIG. 8 is a flowchart for describing a method of manufacturing the matrix multiplication operation device according to an embodiment of the present disclosure.

FIG. 9 is a view showing a difference in configuration according to an operating method of an activation function element of the matrix multiplication operation device according to an embodiment of the present disclosure.

FIG. 10 is a graph showing an experimental result for showing efficiency during current operation of the activation function element inside the matrix multiplication operation device according to an embodiment of the present disclosure.

### DETAILED DESCRIPTION OF THE EMBODIMENTS

Hereinafter, exemplary embodiments according to the present disclosure will be described in detail with reference to the content described in the attached drawings. However, the present disclosure is not restricted or limited by the exemplary embodiments. Unless otherwise defined, all terms (including technical and scientific terms) used herein are to be used with a meaning commonly understood by those having ordinary skill in the art to which this disclosure pertains, but this may vary depending on the intention of those skilled in the art, case law, or emergence of new technologies, etc.

In addition, terms defined in a commonly used dictionary are not to be interpreted ideally or excessively unless clearly and specifically defined otherwise. In a specific case, there are terms that the applicant has arbitrarily selected, and in this case, their meanings will be described in detail in the corresponding description part. Accordingly, the terms used in herein should be defined based on the meaning of the terms and the overall content of the present disclosure, rather than simply the names of the terms.

When it is said throughout this specification that a part “includes” a certain component, this does not exclude other components unless otherwise stated, but means other components may be further included. In addition, the singular forms used herein also include the plural forms unless specifically stated otherwise. In addition, the expression “at least one of a, b, and/or c” described throughout the present specification may encompass “a alone”, “b alone”, “c alone”, “a and b”, “a and c”, “b and c”, or “all of a, b, and c”.

Meanwhile, terms such as “first and/or second” used herein may be used to describe various components, but they are only used for the purpose of distinguishing one component from another component, and are not intended to be limited to the components referred to by the terms. In addition, terms such as “part”, “module”, etc. described herein mean a unit that processes at least one function or operation, which may be implemented by hardware or software, or by a combination of hardware and software.

In addition, terms such as “part”, “module”, etc. described herein mean a unit that processes at least one function or operation, which may be implemented by hardware or software, or by a combination of hardware and software. Additionally, the embodiments of the present disclosure in the present specification may be represented by functional block configurations and various processing steps. The functional blocks may be implemented as any number of hardware and/or software configurations that perform specific functions. For example, the embodiments of the present disclosure may employ direct circuit configurations, such as a memory, processing, logic, and a look-up table that may execute various functions by the control of one or more microprocessors or by other control devices.

Hereinafter, various embodiments of the present disclosure will be described in detail with reference to the attached drawings. In describing the embodiments, a description of technical contents that are well known in the technical field to which the present disclosure pertains and are not directly related to the present disclosure will be omitted. This is to convey the gist of the present disclosure more clearly without obscuring the same by omitting unnecessary explanation. For the same reason, some components in the attached drawings are exaggerated, omitted, or schematically shown. In addition, size of each component does not entirely reflect its actual size. In the present specification, like reference numerals may refer to like or corresponding components throughout.

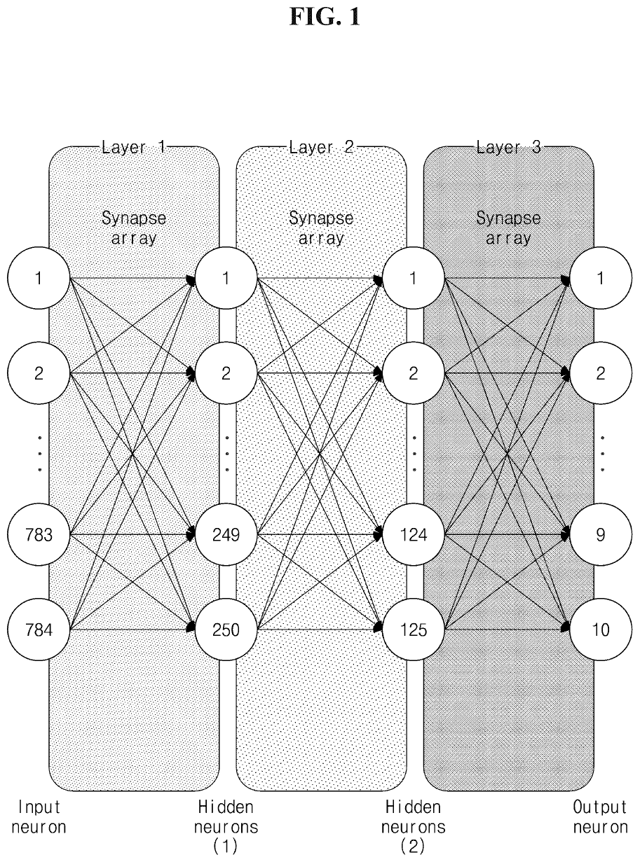

FIG. 1 is a view for describing a basic structure of a neural network according to an embodiment of the present disclosure.

Referring to FIG. 1, the neural network may consist of an input layer (Layer 1), a hidden layer (Layer 2), and an output layer (Layer 3).

The input layer (Layer 1) serves to receive input data in a network through input neurons. The input data is transferred to each neuron, and this data is processed by a weight and an activation function.

The hidden layer (Layer 2) goes through several intermediate steps before processing the data received from the input layer (Layer 1) and transferring the data to the output layer (Layer 3). Each hidden neuron of the hidden layer (Layer2) multiplies an input value according to the weight and passes the result thereof through the activation function to perform nonlinear conversion. The more hidden layer (Layer 2) the network has, the deeper the structure (Deep Neural Network, DNN) and the more complex patterns it may learn.

The output layer (Layer 3) is the last layer of the network and outputs a final prediction value based on the data processed in the hidden layer (Layer 2) through output neurons.

Neuromorphic hardware may perform an operation of the neural network by physically implementing a weight element and an activation function element.

The weight element assigns importance to each signal when processing the data at a connection between the neurons. Each input data is multiplied by the weight, added, and then input into the neurons. A structure in which the weights are gathered may be viewed as a synapse array. The synapse array consists of a plurality of the weight elements and applies a unique weight to each path along which the signal is transferred from various input neurons to the output neurons.

The activation function element nonlinearly converts a value to which the weight is applied and transfers the same to a subsequent layer. Through this, the neural network may learn much more complex functions or patterns compared to a simple linear model. This process is repeated through various hidden layers (Layer 2) from input to output, and as the weight is adjusted during a learning process, the neural network gradually improves a predictive ability. The activation function is used in the hidden neurons and processes an input signal and then nonlinearly converts and outputs the result thereof. The neural network may learn more complex patterns compared to the simple linear model due to the nonlinear conversion.

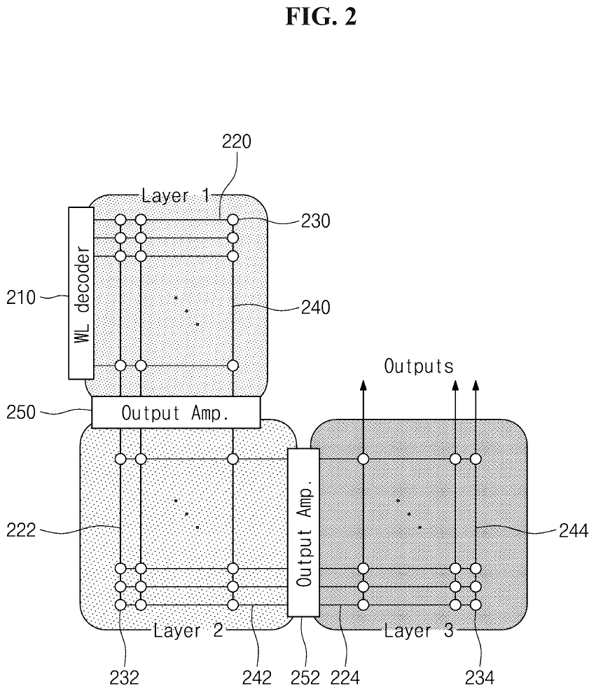

FIG. 2 is a circuit diagram for implementing the neural network structure of FIG. 1 as hardware according to an embodiment of the present disclosure.

Referring to FIG. 2, a wordline decoder 210 may be electrically connected to a plurality of first input lines 220. Each of the first input lines 220 may be connected to a plurality of first weight elements 230. A plurality of the first weight elements 230 may each multiply a signal input through the first input line 220 by the weight and accumulate the value thereof in a first output line 240. A first output amplifier 250 may apply the activation function to a signal input from a plurality of the first output lines 240 to output the converted signal to second input lines 222 of the hidden layer (Layer 2) which is a subsequent layer.

Each of the second input lines 222 may be connected to a plurality of second weight elements 232. A plurality of the second weight elements 232 may each multiply a signal input through the second input line 222 by the weight and accumulate the value thereof in a second output line 242. A second output amplifier 252 may apply the activation function to a signal input from a plurality of the second output lines 242 to output the converted signal to third input lines 224 of the output layer (Layer 3) which is a subsequent layer.

Each of the third input lines 224 may be connected to a plurality of third weight elements 234. A plurality of the third weight elements 234 may each multiply a signal input through the third input line 224 by the weight and accumulate the value thereof in a third output line 244. The signal accumulated in the third output line 244 may be a final output value of the neural network.

Each of the first weight element 230, the second weight element 232, and the third weight element 234 may be a component or material that physically implements a synapse array of the input layer (Layer 1), a synapse array of the hidden layer (Layer 2), and a synapse array of the output layer (Layer 3) in FIG. 1.

The weight element represents a connection strength between the neurons and is a value that may be adjusted during the learning process. A memory element may be used to physically implement the weight element. For example, the weight element may include elements such as a memristor, a resistive random-access memory (RRAM), a phase-change random-access memory (PRAM), and a magnetoresistive random-access memory (MRAM). In addition, the weight element may include more commonly used memory elements such as a ferro-electric random-access memory (FeRAM), a static random-access memory (SRAM), a dynamic random-access memory (DRAM), and a flash memory. However, the present disclosure is not limited to the above-listed examples.

Certain materials other than the element may perform a weighting function.. In particular, materials capable of controlling a weight value in such a way that electrical, magnetic, or optical characteristics of the material changes may be used in the weight element. For example, certain materials such as perovskite, ferro-electric material, vanadium oxide, phase change material, magnetoresistive material, and organic electronic material may also perform the weighting function. However, the present disclosure is not limited to the above-listed examples.

Each of the first output amplifier 250 and the second output amplifier 252 may be the activation function element or a circuit that physically implements the hidden neurons in FIG. 1. Each of the first output amplifier 250 and the second output amplifier 252 may be a circuit including a diode, a metal-insulator transition element, or a metal-oxide-semiconductor field-effect transistor (MOSFET).

The first output amplifier 250 and the second output amplifier 252 may be an amplifier that performs current-mode amplifier operation. The current-mode amplifier is an amplifier that processes an output signal as current rather than voltage. This is used in an application field in which high-speed signal processing and bandwidth are important and may also be efficiently utilized in a neural network circuit. The current-mode amplifier features high-speed signal processing, low power consumption, and wide bandwidth compared to a voltage-mode amplifier.

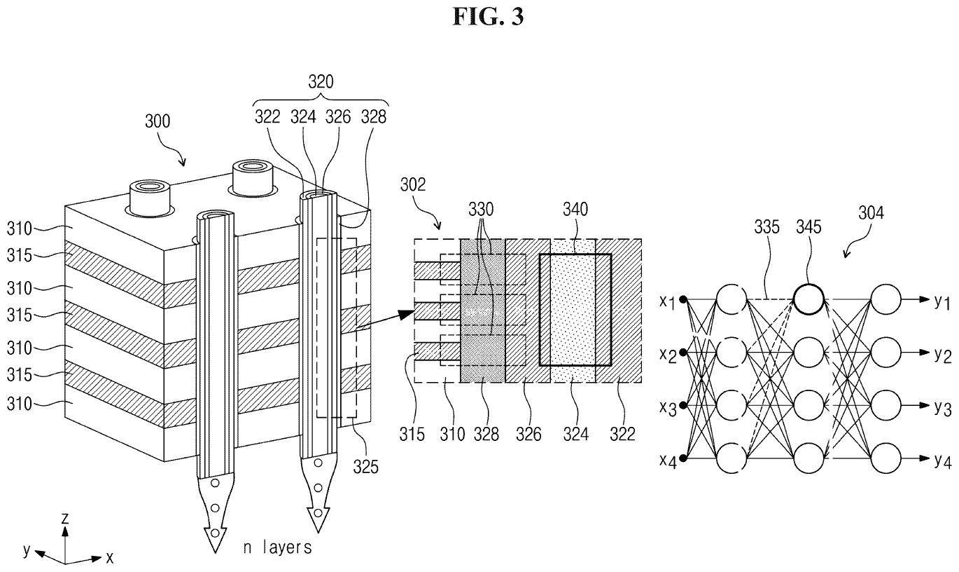

FIG. 3 is a view for describing a structure of a matrix multiplication operation device/element according to an embodiment of the present disclosure.

Referring to FIG. 3, a matrix multiplication operation device 300 according to an embodiment of the present disclosure may be manufactured on various types of substrates. As an example, the matrix multiplication operation device 300 may be manufactured on a silicon substrate. The matrix multiplication operation device 300 may include a plurality of input metal layers 315 disposed in a direction perpendicular to the substrate. The plurality of input metal layers 315 may be electrically conductive and each may act as an electrode that allows the matrix multiplication operation device 300 to receive the input signal. The matrix multiplication operation device 300 may include a plurality of insulating layers 310 that electrically separate the plurality of input metal layers 315. The plurality of insulating layers 310 electrically separate the plurality of input metal layers 315 from each other to distinguish a plurality of the input signals from each other, and prevent a short circuit to assist in stable operation of the matrix multiplication operation device 300.

The matrix multiplication operation device 300 may include a plurality of hole structures extending in the direction perpendicular to the substrate. The plurality of hole structures may penetrate the plurality of input metal layers 315 and the plurality of insulating layers 310, respectively. Each of the plurality of hole structures may be in a cylindrical shape, but the present disclosure is not limited thereto.

Inside of the hole structure 320 may include an output metal pole 322, an activation function layer 324, an intermediate metal layer 326, and a weight layer 328 from the center. The output metal pole 322 may extend from the center of the hole structure 320 in the direction perpendicular to the substrate. The activation function layer 324 may surround the output metal pole 322 and extend in the direction perpendicular to the substrate. The intermediate metal layer 326 may surround the activation function layer 324 and extend in the direction perpendicular to the substrate. The weight layer 328 may surround the intermediate metal layer 326 and extend in the direction perpendicular to the substrate.

Referring to a hole boundary part cross-section 302, the weight layer 328 may constitute a center portion of each of a plurality of weight elements 330. Any one of the plurality of weight elements 330 may include any one of the plurality of input layers 315, a portion of the weight layer 328, and a portion of the intermediate metal layer 326. The plurality of weight elements 330 serve to control importance of the input signal in an artificial neural network. As each input value is multiplied by the weight, a more important input value has a greater influence and less important input value has a smaller influence. The plurality of weight elements 330 are essential elements for the neural network to recognize and predict patterns through learning and are adjusted during the learning process to optimize the output of the network.

An activation function element 340 may include the intermediate metal layer 326, the activation function layer 324, and the output metal pole 322. The activation function element 340 serves to nonlinearly convert and output the input signal in the artificial neural network. Through this, the neural network may go beyond simple linear conversion and solve complex pattern recognition or nonlinear problems. The activation function element 340 determines the output of neurons 345 and assists in learning and generalization of the neural network. Representative activation functions include a rectified linear unit (ReLU) function, a sigmoid function, a tan h function, etc., but the present disclosure is not limited thereto.

Referring to a neural network model 304 and the hole boundary part cross-section 302, a synapse 335 may correspond to any one of the weight elements 330. The neurons 345 may correspond to the activation function element 340.

When described in a perspective of signal movement, the plurality of input signals may each be applied to the weight elements 330 in a direction parallel to the substrate through the plurality of input metal layers 315. The plurality of weight elements 330 may each multiply the input signal by the weight and output a signal to the intermediate metal layer 326. An intermediate signal, which is an accumulated signal, may remain at the intermediate metal layer 326. The intermediate signal may again be the input value of the activation function element 340. The activation function element 340 may generate the output signal by nonlinearly responding to the intermediate signal and output the output signal to the output metal pole 322. The output metal pole 322 extends in the direction perpendicular to the substrate, and thus the output signal may also move in the direction perpendicular to the substrate.

The activation function element 340 of the matrix multiplication operation device/element according to the present disclosure may perform current operation. In other words, the activation function element 340 may generate an output in response to a current input. Specifically, current flows in the direction perpendicular to the substrate along the intermediate metal layer 326, and a nonlinear response to the corresponding current value may be output to the output metal pole 322.

Unlike a conventional method of implementing a circuitry method for matrix multiplication operation, the matrix multiplication operation device/element according to the present disclosure may only use the weight elements 330 corresponding to the synapse 335 and the activation function element 340 corresponding to the neurons 345. The plurality of weight elements 330 accumulate and transfer the signal to a single activation function element 340 and may be utilized as an element capable of performing the matrix multiplication operation without an additional circuit between the activation function element 340 and the plurality of weight elements 330 due to the current operation of the activation function element 340.

The matrix multiplication operation device/element according to an embodiment of the present disclosure may easily stack the weight elements 330 in the direction perpendicular to the substrate. In other words, it is possible to implement the matrix multiplication operation device/element in three dimensions, thereby significantly improving an integration degree of the element to significantly increase an operation performance that may be implemented in the same area.

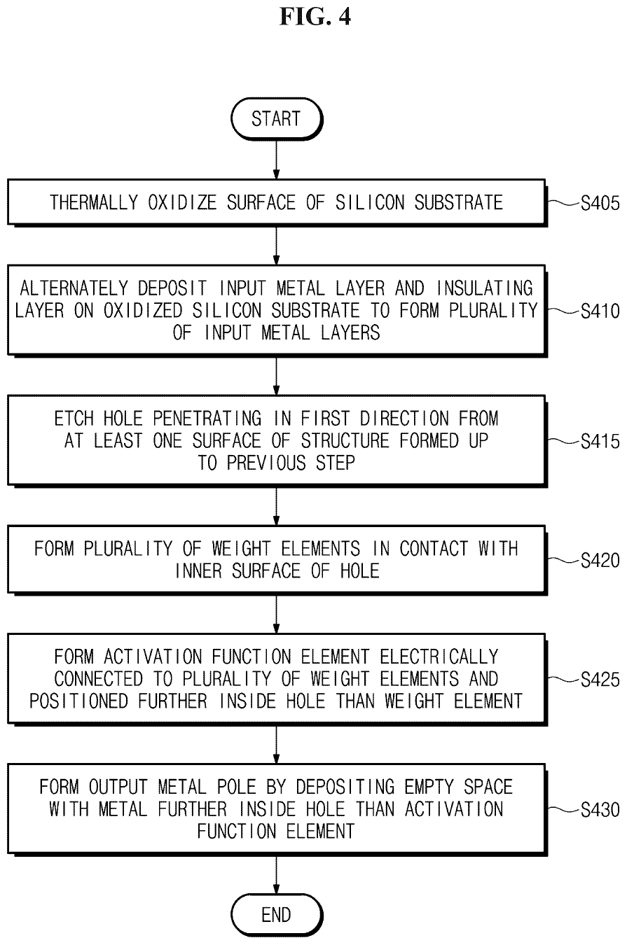

FIG. 4 is a flowchart describing a method of manufacturing a matrix multiplication operation element according to an embodiment of the present disclosure.

Referring to FIG. 4, the method of manufacturing the matrix multiplication operation element may include oxidizing a substrate (S405), alternately depositing an input metal layer and an insulating layer (S410), etching a hole (S415), forming a weight element (S420), forming an activation function element (S425), and forming an output metal pole (S430).

The oxidizing of the substrate (S405) may form a silicon oxide (SiO2) film by applying heat to one surface of a silicon substrate. However, the present disclosure is not limited thereto, and another substrate may be utilized to treat the surface to be non-conductive rather than the thermal oxidation process of the silicon substrate.

The alternately depositing of the input metal layer and the insulating layer (S410) may alternately deposit the plurality of insulating layers 310 and the plurality of input metal layers 315 on a surface of the oxidized silicon substrate.

The deposition of the plurality of insulating layers 310 is a process used for electrical insulation and may thinly coat an insulating material such as silicon oxide (SiO₂) and nitride (Si₃N₄) on the surface. Methods such as a chemical vapor deposition (CVD) method and a physical vapor deposition (PVD) method may be used, but they are not limited thereto.

The deposition of the plurality of input metal layers 315 is a process that forms a wire or a thin film through which current may flow and may thinly coat metal on the surface. Metals such as aluminum (Al), copper (Cu), and tungsten (W) may be used, but they are not limited thereto, and processes such as sputtering or evaporation method may be used as the deposition method.

The etching of the hole (S415) may form the hole structure 320 penetrating in the direction perpendicular to the substrate from one side surface of the structure formed up to step S410 (a state in which the insulating layer and the input metal layer are alternately formed on the substrate). A wet etching method using a chemical solution and a dry etching method using plasma may be used as the etching method. However, dry etching may be more suitable as it is advantageous in creating a deep hole. The present disclosure is not limited to the two etching methods and may include any method capable of forming a hole on a wafer, such as laser drilling and mechanical drilling.

The forming of the weight element (S420) may form the plurality of weight elements 330 that are in contact with an inner surface of the hole. Specifically, after forming the weight layer 328 on the inner surface of the hole, the intermediate metal layer 326 may be deposited on the inner surface again. The weight layer 328 may provide a function of adjusting the weight value by utilizing characteristics such as resistance change, current flow control, or charge storage. Specifically, the weight layer 328 may include a phase change material (e.g., germanium-antimony-tellurium (GST)), a resistance change material (e.g., HfO2, TiO2), a ferro-electric material (e.g., lead zirconate titanate (PZT), HfZrO), a magnetoresistive material (e.g., CoFeB), and other metal oxides, but it is not limited thereto.

The forming of the activation function element (S425) may form the activation function layer 324 on an inner surface of the intermediate metal layer 326. The activation function element 340 may be electrically connected to the plurality of weight elements 330 through the intermediate metal layer 326. The activation function layer 324 may be a suitable material for controlling current flow and simulating spiking motion by utilizing nonlinear characteristics for a current input. Specifically, the activation function layer 324 may be the phase change material (e.g., GST), the metal oxide (e.g., HfO, TiO), and the ferro-electric material (e.g., HfZrO), but it is not limited thereto.

The forming of the output metal pole (S430) may form the output metal pole 322 by filling an empty space inside with metal after forming the activation function element.

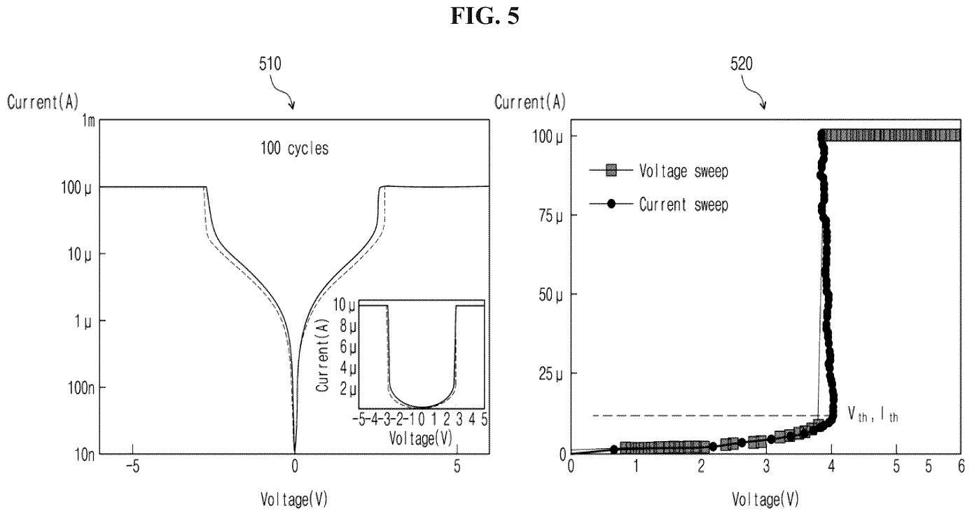

FIG. 5 is a graph for describing transfer characteristics of a metal-insulator transition (MIT) element, which is an exemplary activation function element inside the matrix multiplication operation device according to an embodiment of the present disclosure.

Referring to FIG. 5, a large graph inside a left step graph 510 represents signal transfer characteristics with an x-axis as input voltage and a y-axis as output current (log scale). A small graph at a lower left corner inside the left step graph 510 represents the signal transfer characteristics with the x-axis as the input voltage and the y-axis as the output current (linear scale). As the voltage applied to the element approaches 0 V, the output current of the element also approaches 0 V. When positive or negative voltage is applied to the element with an increasing magnitude, the output current gradually changes at first, then a section is generated in which the output current increases sharply when a certain threshold is reached. Such characteristics may be seen more clearly in the linear scale graph.

A right step graph 520 represents the signal transfer characteristics with the x-axis as the voltage (linear scale) and the y-axis as the current (linear scale). One piece of data inside the right step graph 520 shows how the output current changes when the voltage is applied as an input. Another piece of data shows how the output voltage changes when the current is applied as the input. A nonlinear response (step function as an example here) may be confirmed in both the voltage operation method and the current operation method. When specifically describing the current operation, when about 10 uA is gathered at the intermediate metal layer 326 that is an input terminal of the activation function element 340 through the plurality of weight elements 330, the output voltage increases sharply and a signal may be transferred through the output metal pole 322.

The left step graph 510 and the right step graph 520 are both graphs for describing the transfer characteristics of the MIT element that is the activation function element 340 according to an embodiment of the present disclosure. However, the present disclosure is not limited to the MIT element exemplified as the activation function element 340 (i.e., neuron element) and includes other elements capable of three-dimensional implementation while responding nonlinearly. For example, a diode, a circuit including a MOSFET, an ovonic threshold switch (OTS), a threshold switch (TS) element, etc. may be included, but it is not limited to the elements exemplified by the present disclosure.

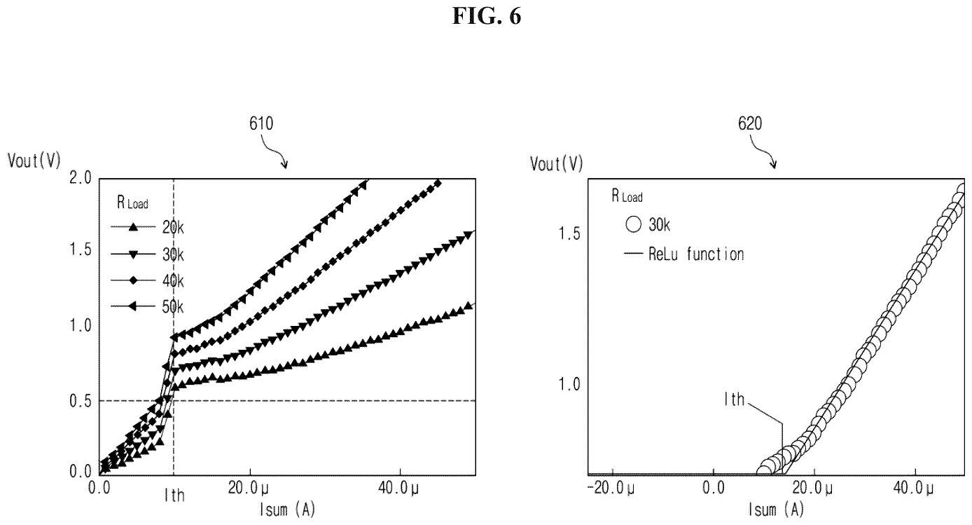

FIG. 6 is a graph for describing another transfer characteristics of the MIT element, which is the exemplary activation function element inside the matrix multiplication operation device according to an embodiment of the present disclosure.

Referring to FIG. 6, a left Relu graph 610 represents the signal transfer characteristics with the x-axis as the input current and the y-axis as the output voltage (linear scale). As a sum of the current flowing at the input terminal of the element approaches 0, the output voltage of the element also approaches 0V. When positive current is applied to the element with an increasing magnitude, the output voltage changes nonlinearly at first, then a section is generated in which the output voltage increases linearly when a certain threshold (Ith) is reached. Such characteristics are still maintained even when a load resistance value (Rload) is changed. However, an inclination of the linearly increasing section may differ depending on the resistance value (Rload). The larger the resistance value (Rload) is, the greater the inclination may be.

The right linear graph 620 shows an example of implementing the Relu function by enlarging only a part that shows a linear response for an input above the threshold (Ith) and making an output for an input below the threshold (Ith) 0V when the load resistance value (Rload) is 30k in the left linear graph 610. The right linear graph 620 also represents the signal transfer characteristics with the x-axis as the input current and the y-axis as the output voltage (linear scale).

The left linear graph 610 and the right linear graph 620 are both graphs for describing the transfer characteristics of the MIT element that is the activation function element 340 according to an embodiment of the present disclosure. However, the present disclosure is not limited to the MIT element exemplified as the activation function element 340 (i.e., neuron element) and includes other elements capable of three-dimensional implementation while responding nonlinearly. For example, a diode, a circuit including a MOSFET, an OTS, a TS element, etc. may be included, but it is not limited to the elements exemplified by the present disclosure.

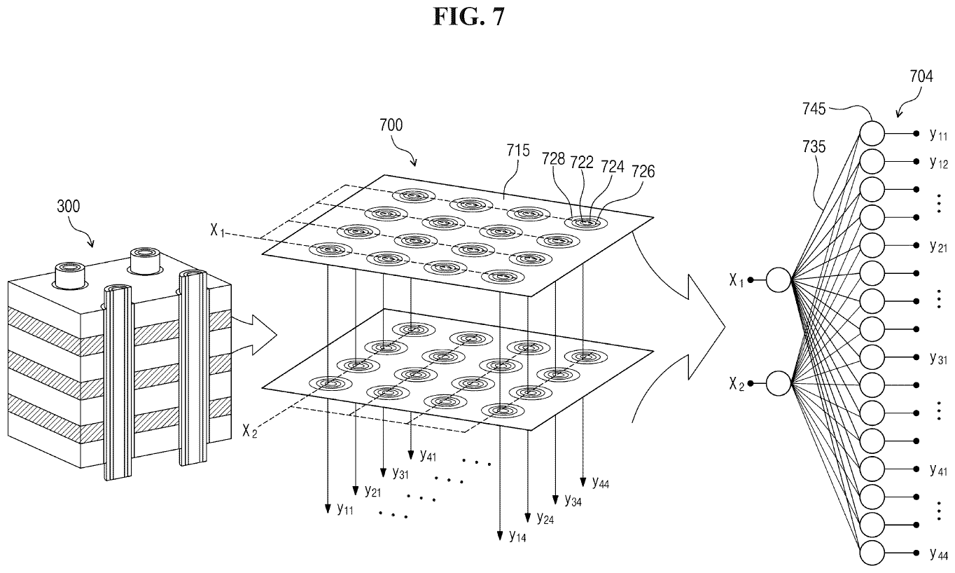

FIG. 7 is a view for describing an operation of the matrix multiplication operation device 300 according to an embodiment of the present disclosure in association with a matrix multiplication operation concept diagram 700 and a single-layer neural network model 704.

Referring to FIG. 7, a first input signal (x1) may be applied to a conceptual input layer 715. The conceptual input layer 715 may correspond to any one of the plurality of input metal layers 315 inside the matrix multiplication operation device 300. A conceptual weight layer 728 may output a signal to a conceptual intermediate layer 726 by multiplying the first input signal (x1) by the weight. An input signal (e.g., x2) in another layer is also multiplied by the weight and outputs a signal to the intermediate layer 726, and the signal may be accumulated. The conceptual weight layer 728 and the conceptual intermediate layer 726 may correspond to the weight layer 328 and the intermediate metal layer 326 inside the matrix multiplication operation device 300, respectively. An intermediate signal accumulated in the conceptual intermediate layer 726 may output a nonlinear response to the conceptual output post 722 by the conceptual activation function layer 724. The conceptual intermediate layer 726, the conceptual activation function layer 724, and the conceptual output post 722 may correspond to the intermediate metal layer 326, the activation function layer 324, and the output metal pole 322 inside the matrix multiplication operation device 300, respectively.

The matrix multiplication operation device 300 is more efficient as an artificial intelligence accelerator than simply performing the matrix multiplication operation because the nonlinear response is output from the activation function layer 324 corresponding to the conceptual activation function layer 724.

A synapse model 735 and a neuron model 745 of the single-layer neural network model 704 may correspond to any one of the plurality of weight elements 330 and the activation function element 340 inside the matrix multiplication operation device 300, respectively. Details on the signal movement in relation to FIG. 7 are omitted as they are included in the description of FIG. 3.

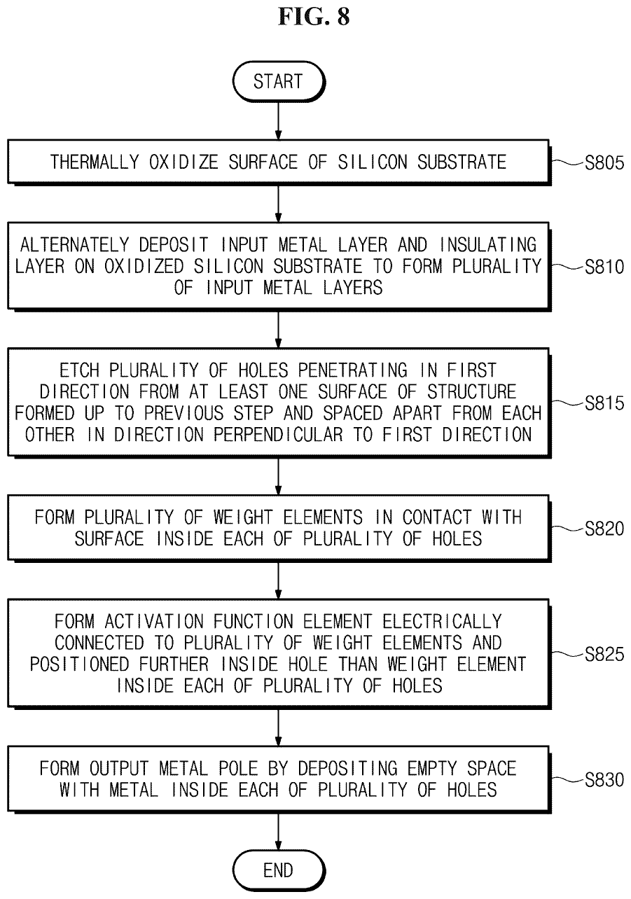

FIG. 8 is a flowchart for describing a method of manufacturing the matrix multiplication operation device according to an embodiment of the present disclosure.

Referring to FIG. 8, the method of manufacturing the matrix multiplication operation device may include oxidizing a substrate (S805), alternately depositing an input metal layer and an insulating layer (S810), etching a plurality of holes (S815), forming a plurality of weight elements inside each of the plurality of holes (S820), forming an activation function element inside each of the plurality of holes (S825), and forming an output metal pole inside each of the plurality of holes (S830).

The oxidizing of the substrate (S805) may form a silicon oxide (SiO2) film by applying heat to one surface of a silicon substrate. However, the present disclosure is not limited thereto, and another substrate may be utilized to treat the surface to be non-conductive rather than the thermal oxidation process of the silicon substrate.

The alternately depositing of the input metal layer and the insulating layer (S810) may alternately deposit the plurality of insulating layers 310 and the plurality of input metal layers 315 on a surface of the oxidized silicon substrate. Description of the specific process is omitted as it is the same as step S410 of FIG. 4.

The etching of the plurality of holes (S815) may form a plurality of the hole structures 320 penetrating in the direction perpendicular to the substrate from one side surface of the structure formed up to step S810 (a state in which the insulating layer and the input metal layer are alternately formed on the substrate). Description of the specific process is omitted as it is the same as step S415 of FIG. 4.

The forming of the plurality of weight elements inside each of the plurality of holes (S820) may form the plurality of weight elements 330 that are in contact with an inner surface of each hole. Specifically, after forming the weight layer 328 on the inner surface of each of the holes, the intermediate metal layer 326 may be deposited on the inner surface again. Description of a more specific process is omitted as it is the same as step S420 of FIG. 4.

The forming of the activation function element inside each of the plurality of holes (S825) may form the activation function layer 324 on an inner surface of the intermediate metal layer 326 inside each hole. The activation function element 340 may be electrically connected to the plurality of weight elements 330 through the intermediate metal layer 326. Description of a more specific process is omitted as it is the same as step S425 of FIG. 4.

The forming of the output metal pole inside each of the plurality of holes (S830) may form the output metal pole 322 by filling an empty space inside with metal after forming the activation function element 340 inside each hole.

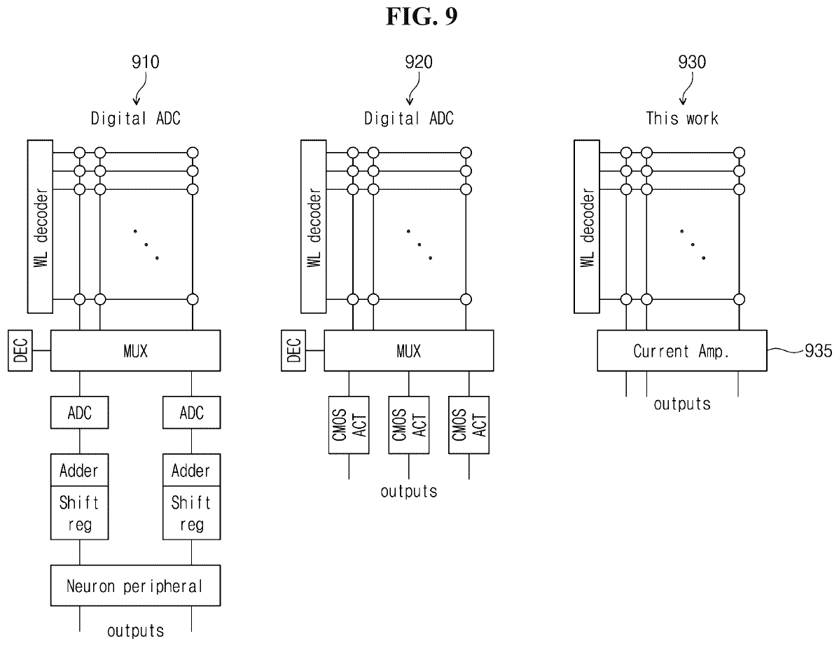

FIG. 9 is a view showing a difference in configuration according to an operating method of an activation function element of the matrix multiplication operation device according to an embodiment of the present disclosure.

Referring to FIG. 9, a method utilizing an analog-to-digital converter 910 requires a decoder (DEC), a multiplexer (MUX), an analog-to-digital converter (ADC), an adder, a shift register, and a neuron peripheral circuit to process an output value. A method utilizing an analog complementary metal-oxide-semiconductor (CMOS) 920 requires the decoder (DEC), the multiplexer (MUX), and a CMOS activation circuit (ACT) to process the output value. A method utilizing a current amplifier 930 may be simply configured with only a current amplifier 935 at an output terminal unlike the above-mentioned method.

The current amplifier 935 according to an embodiment of the present disclosure may have the input signal as current and the output signal as voltage or current. The current amplifier 935 may be implemented as the activation function element 340 of the matrix multiplication operation device 300.

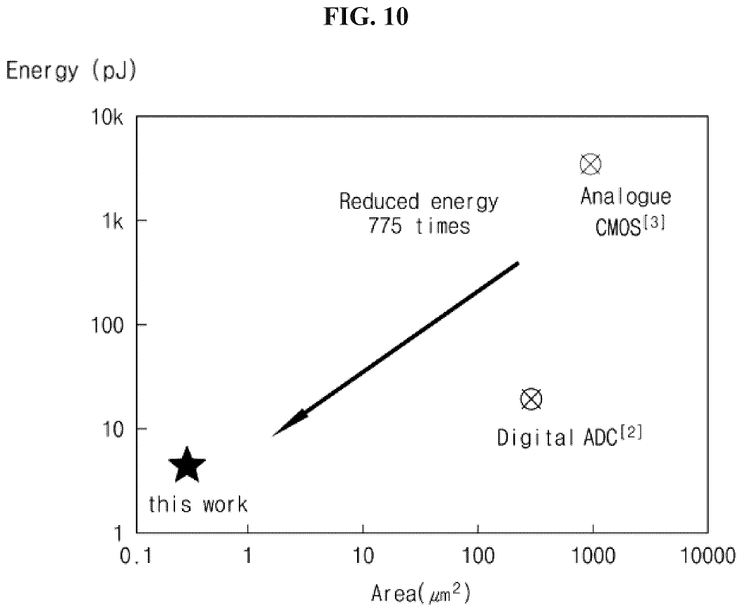

FIG. 10 is a graph showing an experimental result for showing efficiency during current operation of the activation function element inside the matrix multiplication operation device according to an embodiment of the present disclosure.

Referring to FIG. 10, it may be seen that in the matrix multiplication operation device (using the current amplifier) according to an embodiment of the present disclosure is superior in terms of both energy and area compared to a matrix multiplication operation device using other methods (using the analog-to-digital converter or analog CMOS). 4.39 pJ of energy is used when using the current amplifier, which is an experimental energy improvement of approximately 775 times compared to when using the analog CMOS.

The above-described contents are specific embodiments for practicing the present disclosure. The present disclosure will include not only the above-described embodiments, but also embodiments that are simply designed or can be easily changed. In addition, the present disclosure will also include techniques that can be easily modified and implemented using the above-described embodiments. Therefore, the scope of the present disclosure should not be limited to the above-described embodiments, but should be defined not only by the claims described below but also by equivalents of the claims of the present disclosure.

What is claimed is:

1. A matrix multiplication operation device comprising:
a plurality of input metal layers disposed in a direction perpendicular to a substrate;
a plurality of insulating layers that electrically separate the plurality of input metal layers; and
a plurality of hole structures extending in the direction perpendicular to the substrate and penetrating the plurality of input metal layers and the plurality of insulating layers, respectively,
wherein inside of each of the plurality of hole structures includes an output metal pole extending in the direction perpendicular to the substrate, an activation function layer surrounding the output metal pole and extending in the direction perpendicular to the substrate, an intermediate metal layer surrounding the activation function layer and extending in the direction perpendicular to the substrate, and a weight layer surrounding the intermediate metal layer and extending in the direction perpendicular to the substrate.

2. The matrix multiplication operation device of claim 1, wherein the weight layer constitutes a center portion of each of a plurality of weight elements disposed in the direction perpendicular to the substrate.

3. The matrix multiplication operation device of claim 2, wherein each of the plurality of weight elements receives an input signal in a direction parallel to the substrate through the plurality of input metal layers.

4. The matrix multiplication operation device of claim 3, wherein the output metal pole of the inside of each of the plurality of hole structures outputs an output signal in the direction perpendicular to the substrate.

5. The matrix multiplication operation device of claim 4, wherein the input signal is in a current form.

6. A matrix multiplication operation element comprising:
an output metal pole extending in a direction perpendicular to a substrate;
an activation function layer surrounding the output metal pole and extending in the direction perpendicular to the substrate;
an intermediate metal layer surrounding the activation function layer and extending in the direction perpendicular to the substrate;
a weight layer surrounding the intermediate metal layer and extending in the direction perpendicular to the substrate;
a plurality of input metal layers that are in contact with the weight layer in a direction parallel to the substrate and disposed in the direction perpendicular to the substrate; and
a plurality of insulating layers that electrically separate the plurality of input metal layers.

7. The matrix multiplication operation element of claim 6, wherein the intermediate metal layer, the weight layer, and the plurality of input metal layers constitute a plurality of weight elements.

8. The matrix multiplication operation element of claim 7, wherein the plurality of weight elements receive an input signal in the direction parallel to the substrate through the plurality of input metal layers.

9. The matrix multiplication operation element of claim 8, wherein the output metal pole outputs an output signal in the direction perpendicular to the substrate.

10. The matrix multiplication operation element of claim 9, wherein the input signal is in a current form.
